(19) United States
(12) Patent Application Publication
(10) Pub. No.: US 2011/0010236 A1
(43) Pub. Date: Jan. 13, 2011

(54) PORTABLE, ORGANIZED, SUSTAINABLE, TRANSPARENT AND TECHNOLOGICAL ALTERNATIVE PORTFOLIO MANAGEMENT SYSTEM AND BUSINESS METHOD

(76) Inventor: MICHELLE BAYANA TRILLANA, BAY (PH)

Correspondence Address: Michelle Bayana Trillana, Hopes Up Integrated Services Inc., 219 Revilleza St. Bgy. Timugan, Los Banos, Laguna, 4030, PH

(21) Appl. No.: 12/834,012

(22) Filed: Jul. 11, 2010

Related U.S. Application Data
(60) Provisional application No. 61/224,852, filed on Jul. 11, 2009.

(51) Int. Cl. G06Q 30/00

(52) U.S. Cl. 705/14.23; 705/14.51

(57) ABSTRACT

The present invention relates to a method of combining an incentive or promotion program with an electronic commerce system as a new and useful improvement to the Art and System of Modern Business Data Processing using different types of Content Management Systems such as a commercial digital directory, reservation system, remote sales personnel system, customer relationship management system, reputation system and digital knowledgebase system over the World Wide Web, for the purpose of providing a compilation of publicly recorded economic activities of individuals and enterprises useful for determining who their customers are, the products and services they need and want; informing customers of their existence; showing customers their products and services and getting them to purchase; tracking resources, and billing and payments; and creating a whole new method of using an incentive program to generate an unlimited number of jobs, sources of income, and fund raising sources for non-profits.

### CROSS-REFERENCE TO RELATED APPLICATIONS

This application claims the benefit of U.S. Provisional Application No. 61224852, entitled “Portable, Organized, Sustainable, Transparent and Technological Alternative Portfolio Management System and Business Method,” filed on Jul. 11, 2009.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD AND INDUSTRIAL APPLICABILITY OF THE INVENTION

The present invention relates to a method of combining an incentive or promotion program with an electronic commerce system as a new and useful improvement to the Art and System of Modern Business Data Processing using different types of Content Management Systems such as a commercial digital directory, reservation system, remote sales personnel system, customer relationship management system, reputation system and digital knowledge base system over the World Wide Web. The business method relates particularly to an electronic commerce system, such as a website, for the purpose of providing a compilation of publicly recorded economic activities of individuals and enterprises useful for determining who their customers are, the products and services they need and want; informing customers of their existence; showing customers their products and services and getting them to purchase; tracking resources, and billing and payments; and creating a whole new method of using an incentive program to generate an unlimited number of jobs, sources of income, and fund raising sources for non-profits. The present invention shall be sold under the trademark POSTTA-FOLIO.

### BACKGROUND OF THE INVENTION

It is common practice to use the Internet as a venue for presenting advertising packages by both individuals and enterprises. These methods range from pay-per-click or pay-per-action basis. Effectiveness and acceptance by Internet users of such Internet advertising products are used by advertisers as their baseline for acceptance of future online advertising packages. Such advertising packages are capable of generating funds for both commercial and non-profit purposes.

Electronic commerce systems serve as electronic or online shopping systems that enable customers to purchase goods and services through electronic means, i.e. with the use of ATM cards, debit cards, credit cards or electronic checks, without having to be physically inside the store if the purchase is made through the WWW. Such systems sometimes include incentive or promo programs to attract repeat sales. Also, some systems have feedback mechanisms that allow customers to give feedback about their purchases both in quantitative and qualitative form.

At present, the Internet has become a source of automated electronic shopping stores that has incentive programs, promotions, billing and payment systems inclusive of funds transfers or credit transactions, and even electronic negotiation. All of these serve as trade stimulus on both the national, and international scenario. And while these web-based systems flourish along with the businesses they help promote, more and more jobs are generated by the brick and mortar businesses that ventured into online sales in the same manner as dot com companies. Availability of the information gained through the Internet has helped in producing enough material for market analysis, micro and macro economic analysis, streamlining business practices.

With the demand for such systems, and the need to conform to standards of computing, especially with regards to the World Wide Web, Content Management Systems were developed. These systems allow both the technical community and the general public to reach a plateau where they could convene to facilitate the software development process to be more understandable, accessible, sustainable and usable to its users.

The inventor identified the potential of collaborating different kinds of Content Management Systems to create an electronic system that could also potentially be a consistent source of livelihood by both the software developers, the users themselves, and even other entities most especially in countries with very low employment rates. The inventor seeks to present a novel method of providing information on income-generating sources through the Internet at the same time using the same system to generate jobs on both a national and international scale and assuring its sustainability. Such a system could also potentially provide a transparent and portable venue for financial accountability monitoring and job performance analysis that could further lead to an even greater way to stimulate trade and new business practices.

### BRIEF SUMMARY OF THE INVENTION

Briefly stated, the present invention relates to a method of combining an incentive or promotion program with an electronic commerce system using a collection of Content Management Systems over the World Wide Web for the purpose of advertising, job generation, and financial accountability monitoring.

It is the purpose of this invention to provide an implementation of the method through the collaboration of a commercial digital directory, member services system, remote sales personnel system, customer relationship management system, reputation system and digital knowledge base system over the World Wide Web.

It is the purpose of this method to provide arrangements of computerized information storage to be collectively called as a portfolio or directory listing made available through the commercial digital directory.

It is the purpose of this method to offer possibly unlimited number of online jobs as independent remote sales and marketing personnel for the online or offline promotion, marketing, and reputation building of new and existing businesses, goods and services portfolios.

It is the purpose of this method to provide the aforementioned independent remote sales and marketing personnel an incentive and commissions monitoring system.

It is the purpose of this method to offer individuals and enterprises a commercial digital directory to advertise their products and services.

It is the purpose of this method to provide a feedback mechanism about the quality and value of products and services based on buyer's evaluation to help build the reputation of its member advertisers to potential and existing customers.

It is the purpose of this method to provide an implementation of a system for compilation of publicly recorded economic activities of individuals and enterprises.

It is the purpose of this method to provide an electronic directory of different livelihood and business activities as reference for business process outsourcing.

It is the purpose of this invention to provide a customer-centered certification of credits and credentials of the individuals and enterprises publicly listed in the aforementioned commercial digital directory.

It is the purpose of this method to improve monitoring of business initiatives for the improvement of decision-making of both business owners and customers.

It is the purpose of this invention to provide an alternative and sustainable source of fund-raising for non-profit organizations.

It is the purpose of this invention to provide a transparent financial accountability monitoring system for non-profit fund-raising.

It is the purpose of this invention to encourage and motivate the commercial and non-profit sectors to implement and improve customer relations.

It is the purpose of this method to mine customer and user data not previously available for compilation of statistical data of particular usages of the different aspects of the system.

It is also the purpose of this invention to stimulate trade on a local, national, and international scale.

### BRIEF DESCRIPTION OF THE SEVERAL VIEWS OF THE DRAWINGS

The foregoing and other objects of this invention, the various features thereof, as well as the invention itself, may be more fully understood from the following description, when read together with the accompanying drawings in which:

FIG. 1A is a functional decomposition diagram illustrating the key systems, subsystems, and functions that constitute the present business method;

FIG. 1B is a continuation of the diagram of FIG. 1A;

FIG. 1C is a continuation of the diagram of FIG. 1A;

FIG. 2 is a block diagram illustrating a system and method of collaborating a commercial digital directory, member services system, remote sales personnel system, customer relationship management system, reputation system and digital knowledge base system as the environment that the network user interacts with according to the present invention;

FIG. 3A is a flow chart illustrating the routine implementation of the events in the present invention, specifically the Member and Non-Member Services of the Digital Directory and the Remote Sales Personnel Management System.

FIG. 3B is a continuation of the flow chart in FIG. 3A illustrating the routine implementation of the events in the present invention, specifically the process of purchasing a listing and the awarding of commissions and donations.

FIG. 3C is a continuation of the flow chart in FIG. 3A illustrating the routine implementation of the events in the present invention, specifically the process to be followed by a non-profit member for fund raising using the present invention.

FIG. 3D is a continuation of the flow chart in FIG. 3A illustrating the routine implementation of the events in the present invention, specifically the tasks of the Administrator in managing the Remote Sales Personnel Management System.

FIG. 3E is a continuation of the flow chart in FIG. 3A illustrating the routine implementation of the events in the present invention, specifically the method of counter checking of donations and donations usage attributed to non-profit members.

FIG. 4 is a diagrammatic view of the server-client architecture of the system and the interfaces for various participants and users to access the information and reports in the present invention.

FIG. 5 is a simplified illustration of the sustainability cycle presented in the business method.

### DETAILED DESCRIPTION OF THE INVENTION

In order to more clearly and concisely describe the subject matter of the specification, the following definitions are intended to provide guidance as to the meanings of specific terms used. Also it is to be understood that the phraseology or terminology employed herein is for the purpose of description and not of limitation. As used herein:

“Content Management System (CMS)” is the term used throughout the whole specification to identify the software used to author, create, edit, manipulate web pages and web content with little or no knowledge of Computer or Web Programming Languages.

“Implemented Website” is the term used throughout the whole specification to identify the website illustrating a sample implementation of the invention. The Implemented Website, for purposes of illustration, shall be at the URL www(dot)postta(dot)com.

“Transactions” is the term that is used throughout the whole specification as a description of the embedded information and functions associated with ensuring that actions done by the personalities involved on their computers and its peripherals through the system's website implementation are interpreted into the necessary machine language necessary to execute the chosen course of action. For example, a click of the mouse button may direct the computer system to access stored data from the websites System Databases 176 with the use of such embedded information. It is not the purpose of this specification to detail the functions, processes and other such content related to the aforementioned embedded information.

“Listing” or “Portfolio” is the term used throughout the whole specification to identify the advertising packages sold through the system.

“Services” include any act of assistance or benefit to other(s), whether for free or paid, such as the services classified according to the Universal Standard Products and Services Classification (UNSPSC) Code, the U.S. Standard Industrial Classification (SIC) system or the like.

“Member” is the term used throughout the whole specification to identify the person who has opted to go through the registration process of the Implemented Website, has passed the Process of New Membership Request 10 and the Process of Membership Requirements Compliance 11 and has been approved by the Administrator 177 as a valid user of the privileged and/or private pages and functions of the system.

“Builder” 181 is the term used throughout the whole specification to identify the system-qualified and verified person responsible for creating, editing, maintaining, and promoting an individual, a commercial or non-commercial entity, a non-profit, or a government agency's services/products through the system's commercial products, such as listings.

“Remote Sales Personnel (RSP)” is the term used throughout the whole specification to identify the Builder 181 that has opted to sell and manage listings for a commission. In layman's terms, a Remote Sales Personnel is a Sales Agent. A Remote Sales Personnel belongs to a multi-tiered commission hierarchy structure. They can be referred to as a tier-one Remote Sales Personnel or a tier-two Remote Sales Personnel and so on. The adjective Remote is also used because their location is determined by where they prefer to do their job as it is mostly Internet-based, which may or may not necessarily be within the area of the business/entity whose portfolio they are trying to sell.

“Buyer” 182 is the term used throughout the whole specification to identify the person or entity interested in purchasing or has already purchased a listing.

“Auctioneer” 183 is the term used throughout the whole specification to identify the third party entity used as a bidding or auction venue for the sale of a listing by a Remote Sales Personnel.

“User” 179 is the term used throughout the whole specification to identify the person who visits, navigates through and uses the public pages and functions of the Implemented Website.

“Administrator” 177 is the term used throughout the whole specification to identify the person responsible for creating, editing, managing, and maintaining the front and back end of the Implemented Website and all its transactions.

“Web/Internet Browser” is the term used throughout the whole specification to identify the application used by all types of users to interact with the Implemented Website through the Internet.

“Web server” 178 is the term used throughout the whole specification to identify a software used to translate a URL either into a filename, and then send that file back over the Internet, or into a program name, and then run that program and send its output back. It is basically responsible for communicating with the Web Browser. The protocols used for communication through the Internet is implicit relevant to the Internet Browser application used, such as but not limited to, Internet Explorer from Microsoft or Mozilla-based Internet Browsers. As such, protocols like Transmission Control Protocol/Internet Protocol (TCP/IP) or Hypertext Transfer Protocol (HTTP) may be used without altering the scope of the invention. The invention can also be implemented using appropriate programming languages also without altering the scope of the invention. Each computer connects to the Internet using software residing on the computer, and access or store information on the Web server

“System Databases” 176 is the term used throughout the whole specification to identify a remote or a local storage device that stores whatever information the Implemented Website requires.

“System Admin” 175 is the term used throughout the whole specification to identify the tasks such as but not limited to adding and deleting user accounts, backing up data, assuring security, and so on, necessary to manage the Implemented Website.

### Commercial Electronic Portfolio Management System

The present invention is a Portable, Organized, Sustainable, Transparent and Technological Alternative Portfolio Management System and Business Method of combining an incentive or promotion program with an electronic commerce system using a collection of Content Management Systems over the Internet for advertising, job generation, sales and marketing monitoring, and financial accountability monitoring implemented as a Commercial Electronic Portfolio Management System 1.

It is the purpose of this invention to provide an implementation of the method through the collaboration of a Digital Directory Content Management System 2, Remote Sales Personnel Content Management System 26, and a Customer Relationship Content Management System 46 over the Internet 180.

The invention is for the use of the following personalities, i.e. a Builder 181, Buyer 182, Auctioneer 183, Administrator 177, and multiple Users 179. All the transactions and activities made by these personalities are done through the use of a communications network such as the Internet 180. All information is stored in and retrieved from the System Databases 176 through the Web server 178.

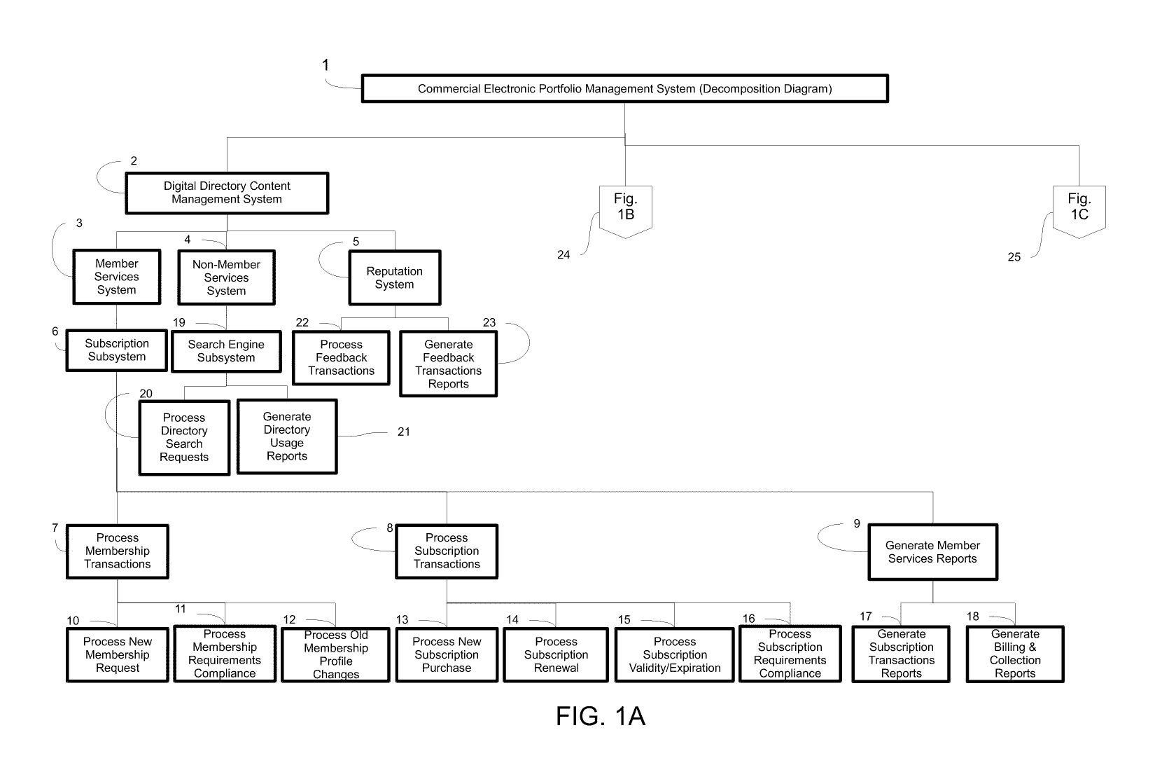

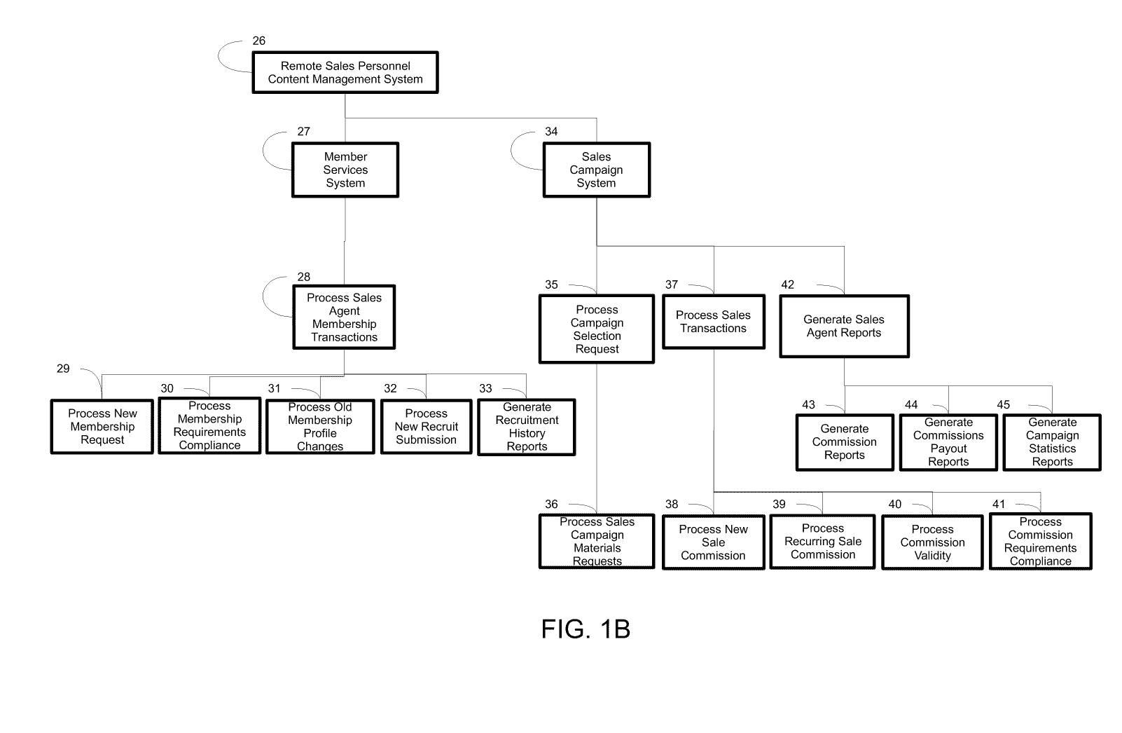

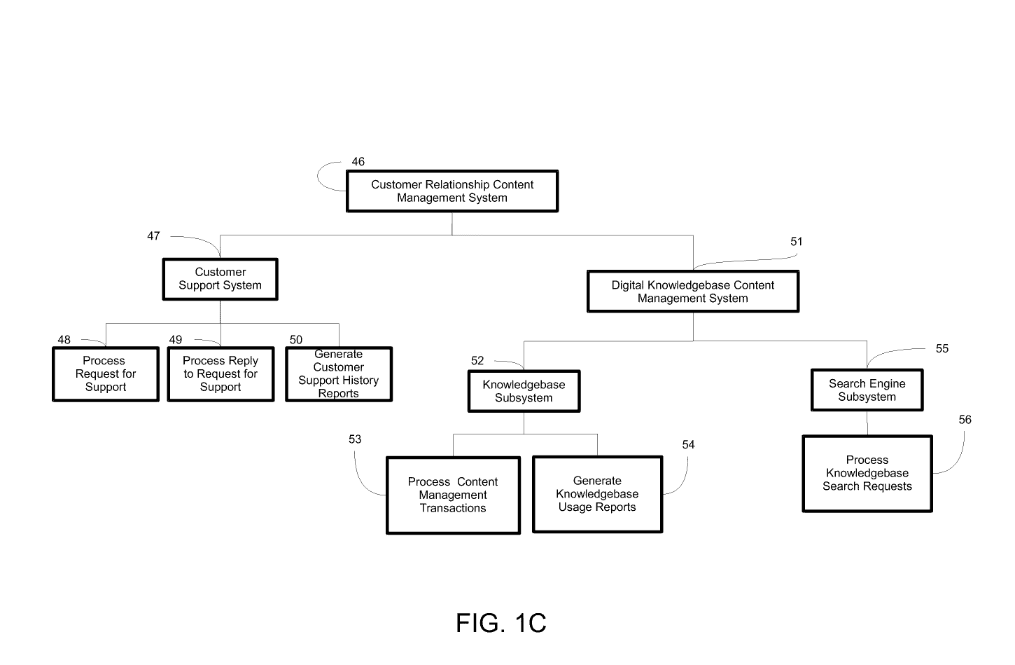

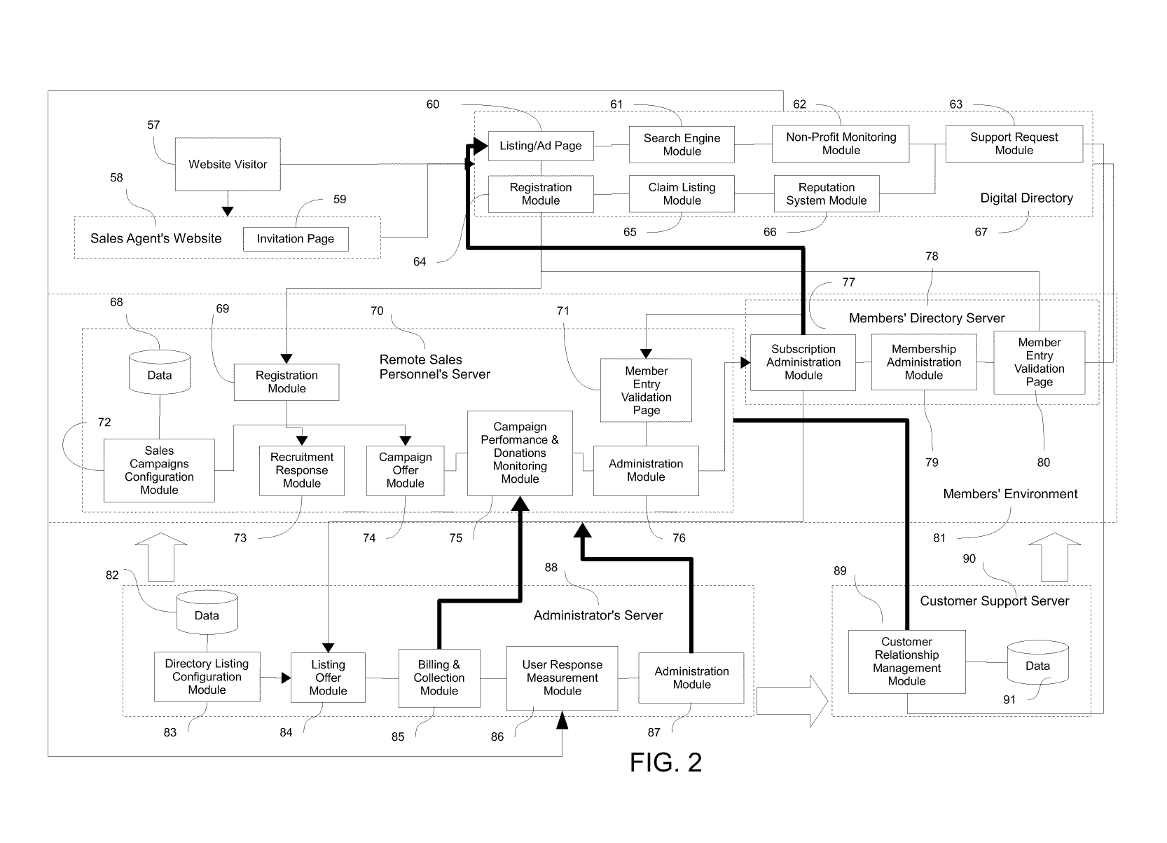

FIG. 1A shows a diagram of a system that can be used to generate commission-based jobs as remote sales and marketing personnel of existing businesses and professionals through the collection, storage and promotion of information about offered services for hire or products for sale presented through the arrangement of Internet-based advertising packages, i.e. business portfolio or digital directory form, combined with a method of using a web-based multi-level incentive or promotion program to provide a transparent and commission-based fund raising scheme for non-profits.

### Digital Directory Content Management System

The Digital Directory Content Management System 2 contains the systems that are needed for the collection, storage and promotion of information about the offered services for hire or products for sale. The arrangement of the advertising packages made available through the Digital Directory Content Management System 2 is called a listing or a portfolio. This listing is the main commercial product used in the implementation of the whole system where sales, commissions and donations will be derived from.

Listing levels that are presented to customers like Builders 181 and Buyers 182 are made available through the Listing Offer Module 84. To form a Listing Offer, the Administrator 177 creates a listing level through the Directory Listing Configuration Module 83. This module gives the Administrator 177 the privilege to indicate the features of a particular listing level to be offered for sale. The basic contents of the listing are the name of the entity that is being promoted, major description of the services/products and contact details. The configuration of these attributes with regards to the type and total number of characters accepted for each type of content is the discretion of the Administrator 177. By convention, free-priced listing levels have less features and attributes than the premium-priced or non-free-priced level listings. This process of listing level configuration is only accessible to an Administrator 177. Once the settings or configuration for each listing level is stored into the system and made available for purchase, such listing levels are displayed through the Listing Offer Module 84. These listing levels are then made available for Builders 181 to choose from.

The creation of a listing by a Builder 181 starts with the Member Services System 3. This system is in charge of the Subscription Subsystem 6 that controls the processes related to Membership Transactions 7, Subscription Transactions 8, and Member Services Reports 9. These processes are controlled by a Builder 181. The Builder 181 is a user of the system that has passed the Process of New Membership Request 10 and the Process of Membership Requirements Compliance 11 and has been approved by the Administrator 177 as a valid member of the system. Once the Builder 181 has become a verified member, he can create and maintain listings through the Subscription Transactions Process 8 for personal use, for commercial purposes, or for selling and eventual management as a Remote Sales Personnel.

To create a listing, the Builder 181 navigates through the Subscription Transactions Process 8 by going through the New Subscription Purchase Process 13. The Builder thus logs-into his membership account and purchases a new listing and proceeds to enter the appropriate data required to accomplish a listing and make available for display through the Search Engine Subsystem 19.

The basic contents of the listing are the name of the entity that is being promoted, major description of the services/products and contact details. The name of the entity can be any entity that can offer services for hire or sell products. The listing can be arranged by different levels, wherein more fields for data storage can be added to listing arrangements to further provide more information about the entity's services/products. The listing will only be made available for the duration it is configured with, i.e. a monthly listing should go through the Process of Subscription Renewal 14 on a monthly basis. Once a listing reaches a certain date prior to its configured validity/expiration as it undergoes the Process of Subscription Validity/Expiration, the Builder 181 will then be sent a correspondence informing him of such. The Builder 181 can then opt to renew the listing or not. And every time a listing is created or edited then submitted to the system, it will be Processed for Subscription Requirements Compliance 16 before being accepted and made available for display in the Digital Directory.

The collection of listings stored through the System Databases 176 are made available for viewing through the Search Engine Subsystem 19. With the use of inputted keywords by the User 179 through the Search Engine Subsystem interfaces, the data then goes through a Process of Directory Search Requests 20 which is the transaction needed to retrieve data from the System Databases 176 relevant to the inputted keywords by the User 179. The data is then displayed as either a single listing or a collection of listings. These searches are then logged for statistical purposes for the Generation of Directory Usage Reports 21 and the Generation of Subscription Transactions Reports 17. These reports contain information on the frequency of viewing of listings among others that aid the Builder 181 and the Buyer 182 in determining the performance of their advertising strategies.

The aforementioned advertising strategies includes the utilization of the invention's Reputation System 5. Each listing is configured to include an interface that allows User(s) 179 to give their feedback about the services/products specified in the listing. The interface uses a rating scheme that enables User 179 to rate the listing according to a specified visual scoring range and submitting a review to justify the rating given. To Process Feedback Transactions 22 such as the ones stated, the User 179 undergoes certain validation processes to check whether the User 179 is a real person or not to avoid feedback that are computer generated. The feedback submitted is then processed to Generate Feedback Transactions Reports 23 to allow both the User 179 and the Builder 181 to view statistical figures about the feedbacks.

### Remote Sales Personnel Content Management System

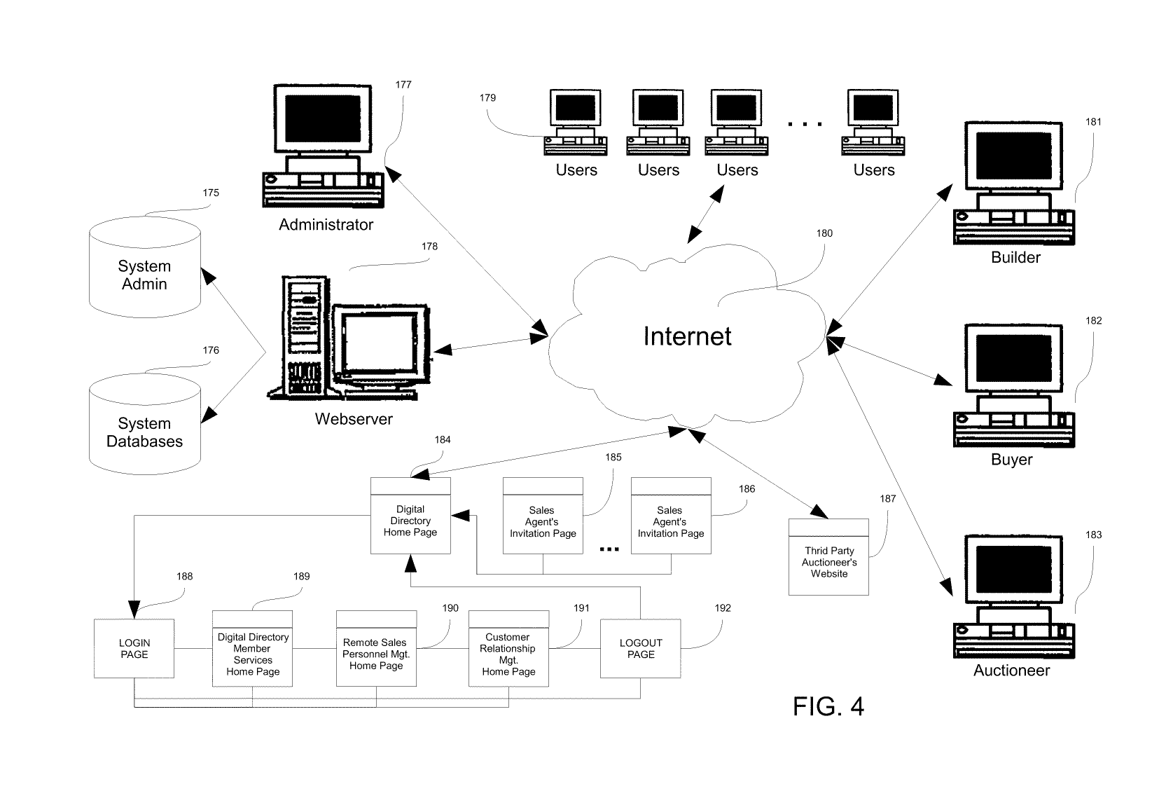

Jobs and income are produced through the Remote Sales Personnel Content Management System 26 of the invention. This system is aptly labeled with the prefix Remote Sales Personnel because the System requires that the entities involved in the transaction are remotely located from the store itself, which is in this invention is the Web server 178. It also requires that the Sales Personnel are really live people since one of the main purposes of this invention is creation of jobs. And to be able to do their jobs as Remote Sales Personnel, they are required to use the Internet to gain access to the invention as a Builder 181 as illustrated in FIG. 4.

### Member Services System

The Member Services System 31 is the part of the Remote Sales Personnel Content Management System 26 that processes the necessary requirements to register, validate, and maintain remote sales personnel profiles. Membership through Subscription System 6 of the the Digital Directory Content Management System 2 is a requirement before a User 179 is viable for acceptance into the Remote Sales Personnel Content Management System 26. The User 179 completes a registration form as the initial step for inclusion into the system as a member. The Process of New Membership Request 29 is then undergone with the initial step followed with the Process of Membership Requirements Compliance 30. When the membership requirements are fulfilled, then the User 179 becomes a Remote Sales Personnel or Remote Sales Agent. Access to the Remote Sales Personnel control panel is validated through the Member Entry Validation Page 71. This allows the Remote Sales Personnel to have access to the Administration Module 87 that contains the modules to Process Old Membership Profile Changes 31, Process New Recruit Submissions 32 and Generate Recruitment History Reports 33.

The Process New Recruit Submissions 32 is the process handled by the Recruitment Response Module 73. Since the implementation of the invention is web-based/Internet-based, this module will be processing referrals to the system from other websites and processed in a manner that would distinguish the source of the referral and the Remote Sales Personnel that the referral will be attributed to. The configuration of the hierarchy with which the module is to record responses will be based on the configuration set by the Administrator 177 in the Sales Campaign Configuration Module 72. The Sales Campaign Configuration Module 72 can be set to have a multiple-tier recruitment system, an example of which is a Remote Sales Personnel is on tier 1, his recruits will be on the second tier and can be one or more in number. There can also be additional tiers after the second. On a more common terminology, this is called multilevel marketing. For the purposes of the Implemented Website, the configuration will be two-tiered.

An example of this process would be a User 179 would visit a website with an Invitation Page 59 with a referral link from a Remote Sales Personnel to the Implemented Website. Once User 179 clicks on the referral link, User's 179 Web Browser will be directed to the appropriate web page assigned by the system to either orient the User 179 about the system or to encourage to complete a registration form to make the User 179 a recruit of the Remote Sales Personnel. A record of the User's 179 visit to the Implemented Website will be made on User's 179 computer. This will enable the Remote Sales Personnel to retain ownership of the recruited User 179 in case the User 179 registers as a member on a later date and time. Once User 179 completes the registration form and becomes a Remote Sales Personnel, his status will be the recruit Remote Sales Personnel belonging to tier two of the referring Remote Sales Personnel belonging to tier one. Succeeding Users 179 who will also complete the registration process can also become a Remote Sales Personnel belonging to tier two through the referral of Remote Sales Personnel tier one. The whole process is monitored through the Recruitment Response Module 73 that checks the status of the User 179 and processes whether the User 179 is to be treated as a User 179, a Remote Sales Personnel of a particular tier, or an Administrator 177.

### Sales Campaign System

The basis of all the commissions and income that Remote Sales Personnel will receive from the system is dependent on the Sales Campaign System 34. This system contains the Process for Campaign Selection Requests 35, Processing of Sales Transactions 37, and the Generation of Sales Agent Reports 42.

As a Remote Sales Personnel, marketing materials can be made available through the system to aide in their promotional and recruitment activities. The process begins when the Remote Sales Personnel chooses a Sales Campaign to join that is configured to have its own set of marketing materials, multi-tiered recruitment and commission structure.

The Remote Sales Personnel has the option to choose the sales campaign it will join through the Campaign Offer Module 74. On the Remote Sales Personnel control panel, a list of Sales Campaigns is shown and it is the discretion of the Remote Sales Personnel on which one to choose. It is only upon choosing a particular Sales Campaign to join will the Remote Sales Personnel be able to enjoy the benefits of receiving commissions through the system. It is also the only way that the Campaign Performance and Donations Monitoring Module 75 will take effect for the aforementioned Remote Sales Personnel.

Once the Process for Campaign Selection Request is triggered, the system then records the Sales Campaign the Remote Sales Personnel belongs to. The Remote Sales Personnel then undergoes the Process of Sales Campaign Material Requests 36. Such a request entails, among others, assigning a unique referral ID or number to the Remote Sales Personnel that he can use for marketing purposes. This unique ID can be used in the referral link made clickable to Users 179 and can be used in the Processing of Sales Transactions 37 and Generation of Sales Agent Reports 42.

There are two ways a Remote Sales Personnel can receive commissions. One is when he makes a sale himself and the other is when his recruit makes a sale. So, technically, Remote Sales Personnel receives a commission from tier 1 and tier 2 sales. This is the basic setup for the Implemented Website. However, the Sales Campaign can be configured differently, and the Remote Sales Personnel receives a commission according to the commission attributed to the particular tier. The amount of commission is also dependent on the Sales Campaign configuration.

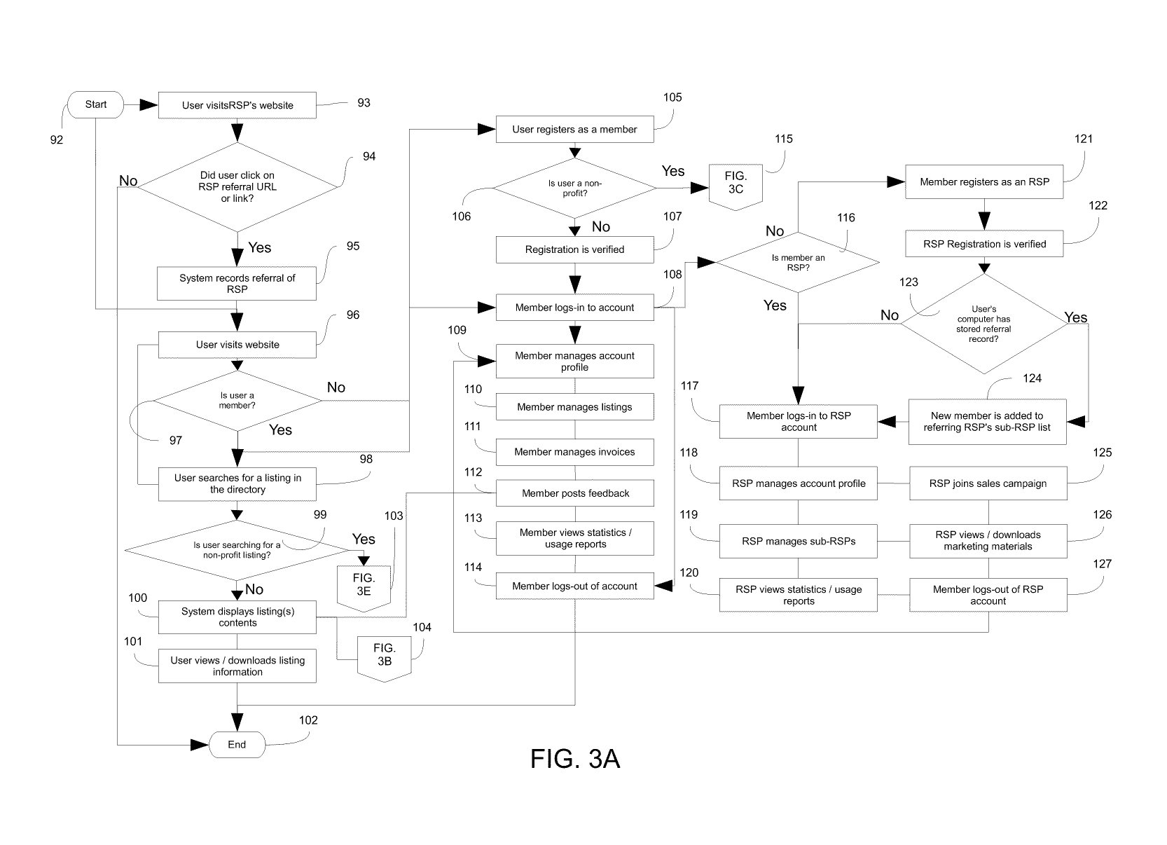

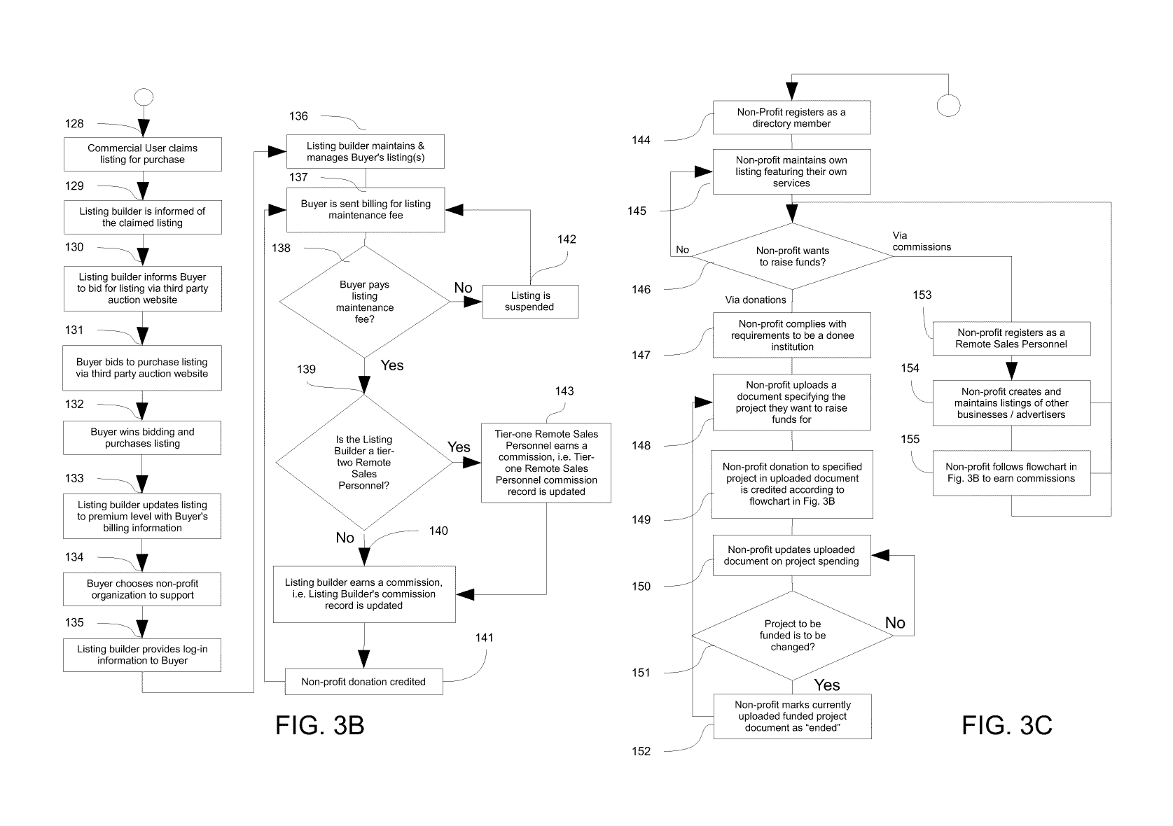

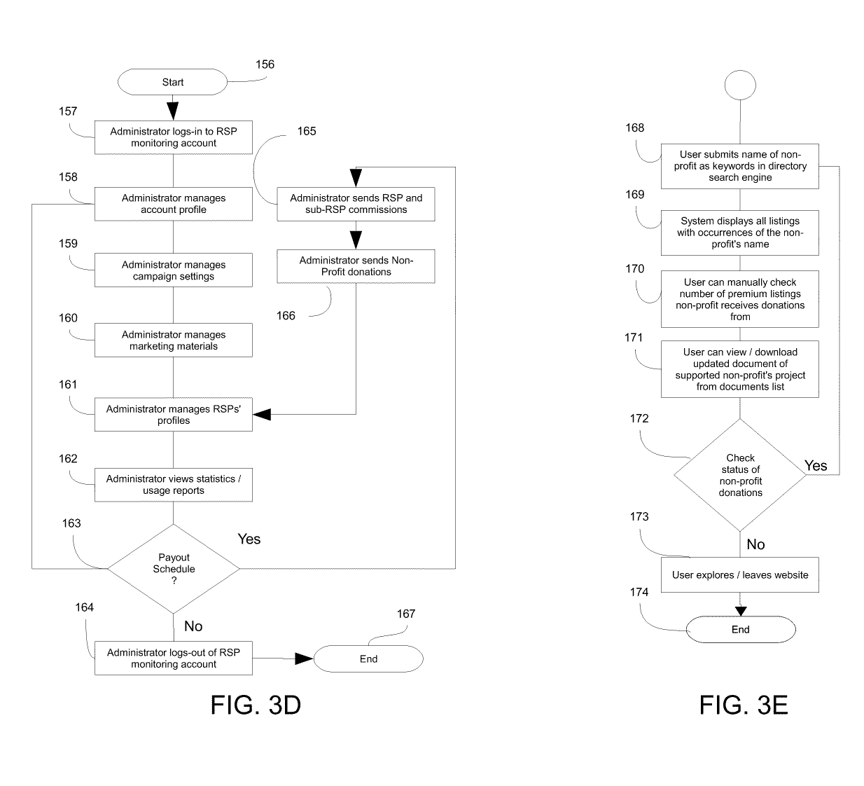

A sale from which a commission is derived is made through the Claim Listing Module 65 wherein the Buyer 182 starts the Process of a Sales Transaction 37 by informing the Remote Sales Personnel of his interest to purchase the listing being offered. The flow of such a purchase is partly illustrated in FIG. 3A from the Start 100 leading to FIG. 3B 135.

FIG. 3B illustrates the steps both the Builder 181 and the Buyer 182 goes through from claiming of the listing until awarding of commissions and donations. Upon display of the listing, an option to claim the listing is given to the User 179. If the Commercial User Claims the Listing for Purchasing 128 purposes, then the flow of FIG. 3B is continued. The Commercial User then is called the Buyer 182 for the purposes of this invention. To claim the listing, the Buyer 182 is made to complete a form to be sent through the system to inform the Builder 181 of his interest to claim the listing. The Listing Builder 181 then corresponds with the Buyer 182 on the process to be followed for the Buyer 182 to completely claim the listing.

The process for claiming a listing is as follows. The Builder 181 informs the Buyer 182 to bid for the listing through a Third Party Auction Website 152. The third party website is an auction website that allows the Builder 181 to offer the listing for sale through a bidding process that will enable him to get the best price for the listing he has created, developed and promoted for the benefit of the business entity featured. During this process, the Third-Party Auctioneer's Website 187 temporarily assumes the role of Auctioneer 183 up until the point when the listing is purchased. The Buyer places his bid to purchase the listing through the Third Party Auctioneer's website 131. After the appropriate span of time the bidding is to take place as specified by the Builder 181, the Buyer who wins the bidding and purchases the listing 132 can stake his legal claim on the listing. Inclusion of such a third party website is part of the novel combination of existing and new components to create an implementation of the invention.

The number of Buyers 182 for a particular listing is not restricted to one or to the owner of the featured business/entity on the listing. Third party Buyers 182 such as but not limited to the featured business/entity's marketing agency, children, friends, or some other personality are allowed to join in the bidding and purchasing process. The invention has no restrictions on the type of people who can claim, post bids, and purchase listings.

Once Buyer 182 has finalized the purchase of the listing, the Builder 181 then assumes a position of outsourced service provider. He then becomes his own business owner as an individual entity hired to manage a portfolio of another business/entity for its further promotional purposes. As part of his new position's responsibilities, Builder updates listing to a premium level with Buyer's billing information 133. The type of premium-level listing that is to be chosen for purchase is dependent on the discretion of the Buyer 182. This step is necessary as the Buyer 182 is now the legal owner of the listing and Builder 181 is given special privileges to edit the listing as a hired service. It is also necessary to upgrade the listing level to a more premium one as the payment for the premium listing is the source of the commissions and donations to be awarded to the appropriate members of the system. Builder provides log-in information to Buyer 135 to signify the finalization of the Buyer's claim to the listing. Builder proceeds to maintain and manage Buyer's listings 136.

The Billing and Collection Module 85 enters a cycle of awarding of commissions and donations as illustrated from Drawing 159 to Drawing 165. On a regular basis, Buyer 182 is sent a bill for the listing maintenance fee 137 equivalent to the rate of the purchased premium listing level. The first time the Buyer pays the bill, it is Processed as a New Sales Commission 38. As long as Buyer pays the listing maintenance fee 138, the Listing Builder earns a commission 140 as a Remote Sales Personnel and a non-profit donation is credited 141. If the Builder 181 is a tier-two Remote Sales Personnel of a tier-one Remote Sales Personnel, the tier-one Remote Sales Personnel also receives a commission 143 from the listing payment made by the Buyer 182. This is the Process of Recurring Sale Commission 39. To make sure that the commission is not repeatedly awarded for the next billing cycle unless it is paid, the Process of Commission Validity 40 and Process of Commission Requirements Compliance 41 are triggered. So, once the listing maintenance fee is not paid, the Listing is Suspended 142 thereby suspending any further issuances of commissions and donations.

This cycle also triggers the Campaign Performance and Donations Monitoring Module 75 that allows the Remote Sales Personnel to monitor his sales, commissions and donations credited to non-profits throughout the validity of the listing. Part of the monitoring process is the Generation of Sales Agents Reports 46. Builder 181 can view his performance as a Remote Sales Personnel by Generating Commission Reports 43, Generating Commissions Payout Reports 44, and Generating Campaign Statistics Reports 45 all available through his Remote Sales Personnel control panel.

The Billing and Collection Module 85 takes care of the necessary functions to inform the Builder 181 or the Buyer 182 in a timely fashion of the amount to be paid for the listing, the expiration of the listing's validity, the method of payment, and the issuance of the invoices or receipts as acknowledgement of receipt of payment. Thus, the billing information of the Buyer 182 is necessary as the Buyer 182 will be sent the regular billing statements for prompting of payment of services derived from the system. These payments serve as triggers for the Campaign Performance and Donations Monitoring Module 75. Each payment becomes the source of commissions and donations awarded to members of a particular Sales Campaign.

### Non-Profit Remote Sales Personnel

Remote Sales Personnel is the term used throughout the whole specification to identify the Builder 181 that has opted to sell and manage listings for a commission. They can also be called Sales Agents in their own rights. As previously mentioned, the Remote Sales Personnel are real live people since one of the purposes of this invention is to generate jobs and sources of income.

As part of the invention's being a novel way of combining new and existing components, the Remote Sales Personnel is described as either a single individual or an organized entity, i.e. a business, an organization, a government agency, or even a non-profit. With this set-up, the Remote Sales Personnel can generate income through the invention for himself/herself or for themselves.

Another part of the invention's being a novel way of combining new and existing components is a non-profit being a Remote Sales Personnel. While it is already self-explanatory and commonly practiced to have commercial-minded individuals and entities engaged in multi-level marketing ventures, non-profits simply become recipients of donations from such commercial-minded individuals and entities. As Remote Sales Personnel they can co-exist in an environment that will allow them to complement each other and provide a sustainable way to support each other's financial needs.

As Remote Sales Personnel, the non-profit has the same benefits when it comes to commissions. However, the non-profit has the prerogative to take advantage of three ways to raise funds from the invention. As a non-profit they have three scenarios to work with. First, the non-profit can join the system itself and function as a Remote Sales Personnel only. Secondly, the non-profit can join the system as a donee institution only, thus making itself available to accept a donation. Thirdly, the non-profit can join the system as both a Remote Sales Personnel and a donee institution to enable them to generate more funds for their projects by combining the income generated through commissions and donations. Another combination that non-profits can avail of is by exploring the potential of allowing their individual staff to act as their tier-one Remote Sales Personnel while the non-profit joins the system as a tier-two Remote Sales Personnel or vice-versa and as a donee institution, thereby providing an incentive to their staff to raise funds for their projects.

FIG. 3C is an illustration of the process to be followed by a non-profit member for fund raising using the present invention. Initially, the non-profit registers as a directory member 144 and proceeds to maintain own listing featuring their own services 145. This facilitates the need for potential donors to request information about the nonprofit they are to choose as a recipient of donations from their subscriptions. As previously stated, a decision should be made as to whether non-profit wants to raise funds 146 using the Implemented Website. To be available to receive donations the nonprofit complies with requirements to be a donee institution 147. The requirements to be complied with are set by the Administrator 177. Upon compliance, the requirement is the Non-Profit upload a document specifying the project that they want to raise funds for 148. This, again, facilitates the need for transparency by potential donors about the nonprofit's fund raising intentions. It is possible for multiple projects to be beneficiaries simultaneously. As shown in FIG. 3B, the non-profit donation is credited 141 after Listing Builder earns a commission 140. The donations credited are monitored through the Campaign Performance and Donations Monitoring Module 75. On the Non-Profit side, they are also given the responsibility to continuously and regularly update the uploaded document on project spending 150 as a constant effort to provide transparency of their fund raising activities. Should the project to be funded is needed to be changed 151 signifying its completion, then Non-Profit marks the currently uploaded funded project document as “ended” 152.

The Non-Profit, if they are to avail of the added benefits to their organization, can also register as a Remote Sales Personnel 153. As an entity, the Nonprofit creates and maintains listings of other businesses/advertisers 154 with the intention of eventually selling them and retaining their position in the system as a Builder 181. To avail of these potential commissions, the Non-profit follows the flowchart in FIG. 3B to earn commissions 155.

The Non-Profit Monitoring Module 62 of the Digital Directory now functions as the method of providing transparency for the whole fund raising activities of the Nonprofit as a donee institution. Besides the uploaded document that contains the financial information concerning the project currently accepting donations, a simple use of the Digital Directory's Search Engine Subsystem 19 as illustrated in detail in FIG. 3E is also method for providing transparency. The User submits name of non-profit as keywords in the directory search engine 168. The System then displays all listings with occurrences of the non-profit's name 169. The User can manually check the number of premium listings the non-profit receives donations from 170. User can also view or download the updated document or the supported non-profit's project from the document list 171. The User can check the status of non-profit donations 172 repetitively in this manner.

### The Recruitment Process

Recruiting other people to become Remote Sales Personnel by the Administrator or by the other Remote Sales Personnel involves the implementation of FIG. 3A. Thus, the Remote Sales Personnel is required to use the available marketing materials or create some of his own and place them on a separate and independent website or web page. Using these marketing materials, an example of the recruitment process is as follows.

Once a potential recruit visits the RSP's website 93, the potential recruit or User 179 has the option to, for example, click the RSP's referral URL or link 94. The act of clicking the referral URL or link triggers the system to record the referral of the RSP 95. The record can be in the form of a cookie, which is a small file saved in the hard disk the potential recruit is using signifying that the referral URL or link was used. After clicking the referral URL or link, the potential recruit's web browser would then be directed to the Implemented Website. As User visits the Implemented Website 96, the system will check if the User is a member 97 or not. If he is not a member, then he will only be able to access the public pages of the Implemented Website. If he opts to access the privileged pages of the Implemented Website and/or become a Remote Sales Personnel, then the User needs to register as a member 105. If the User is a Non-Profit 131 and would like to enjoy the benefits of a non-profit member, then the registration process continues with FIG. 3C 115 as explained previously. If User is not a non-profit, then his registration is verified 107. Completion of the verification process gives the new member the permission to proceed with the registration process to be a Remote Sales Personnel.

If the member then decides to be an RSP, then the member registers as an RSP 121. Once RSP registration is verified 122, the User's computer is then checked if it has the stored referral record 123, e.g. the cookie. If the referral record is present, then the new member is added to the referring RSP's sub-RSP list 124. Thus, the new member is recorded as tier-two RSP and the RSP who referred him/her to join the system is now the tier-one RSP. Subsequent potential recruits who undergo the same process will all become tier-two RSPs of the referring tier-one RSP. However, if the new member was led to the Implemented Website without clicking on any referral URL or link, for example, and simply registered as a member and an RSP on his own, then he/she will be a tier-one RSP.

For the administration of his account as an RSP, he should log-in to his RSP account 117. In his account panel, the RSP can manage his account profile 118, join a sales campaign 125, view/download marketing materials 126, manage sub-RSPs 119, and view statistics/usage reports 120 of his and his sub-RSP's performance as Remote Sales Personnel. The benefits of usage of the public and privileged pages of the Implemented Website are now made available for use by the Remote Sales Personnel.

### Reputation System

As part of the invention's being a novel way of combining new and existing components, the Reputation System, a review and rating method that is commonly used in customer surveys and other websites, is implemented with the intention of serving four purposes. One is raising the market value of the listings of the Digital Directory created and maintained by Builder 181 to enable them to sell their managed listings, as Remote Sales Personnel, at a price inclusive of not only the cost of maintaining it but with the cost of their labor and effort in developing them. The second intention is to enable potential employers and customers a centralized and independent venue to assess the viability of hiring the services or purchasing the products of the business/entity featured in the listing. Third is to enable small to medium business players to potentially gain a global market through the feedback displayed on their listing based on their performance on the local scene. And fourth, for business executives/owners to acquire a portable and cost-efficient method of directly receiving feedback from their customers as a means to further understand their needs and their services'/products' actual performance.

The Reputation System Module 66 is integrated in the system as simply an interface within the Digital Directory that enables Members to post feedback 112. This is done by a User 179 posting a rating of a listing on a scale of 1 to 5 and their review in the form of worded comments. These ratings and reviews are then made available for viewing by User 179 on the listing page.

### Customer Relationship Content Management System

FIG. 1C illustrates the systems and subsystems used to foster good customer relationships between the User 179, Buyer 182 the Remote Sales Personnel or Builder 181, and the Administrator 177. Normally, this system is used in other websites as a means for developers and customers to interact for purposes of training, support requests, bug reporting and fixing, project management, and more. For the purposes of this invention, a Customer Relationship Content Management System 46 is used in the same manner.

A Customer Support System 47 is used as a tool for all members to request for support with regards to the use of the invention from both the Administrator 177 and the Remote Sales Personnel. The member navigates the Web browser towards the Customer Relationship Management Home Page 191 to post a message to start the Process to Request for Support 48. The message will enter the queue of the Customer Support System 47 for the Administrator 177 or a Remote Sales Personnel. Once the request is addressed, it serves as a trigger of the Process of Reply to Request for Support 49. These processes are repetitively handled and data about the requests and replies are stored and retrieved through the Customer Support Server 90. The system also makes it possible to Generate Customer Support History Reports 50 to help in the monitoring of the inflow and outflow of requests and replies sent and received through the system.

The Digital Knowledgebase Content Management System 51 is a supplementary system to aid in the training and exchange of information about the operations and navigation of the invention's Implemented Website. The Knowledgebase Subsystem 52 is capable of Processing Content Management Transactions 53 that entail adding, deleting and editing of the knowledgebase's content. Such content is added by all and any personality (i.e. Administrator 177, User 179, Builder 181, Buyer 182) that desires to add information in the form of a question or narrative content, on the operation and navigation of the invention's Implemented Website. The system also allows for the Generation of Knowledgebase User Reports 54 for administration and monitoring purposes.

The Digital Knowledgebase Content Management System 51 contains a Search Engine Subsystem 55 that serves to Process Knowledgebase Search Requests 56. It facilitates the need of the Users 179 for speed in searching for a particular type of content to aid in the understanding of the operations and navigation of the Implemented Website.

The Customer Relationship Content Management System 46 provides the Administrator 177 and the Remote Sales Personnel a venue to address the questions that Buyers 182 and Users 179 and other Remote Sales Personnel might have about the system without having to create a system on their own or duplicating the process of replying to questions that have been asked previously by others. It can also serve as a venue to provide the necessary insight as to further improve this invention.

### The Administrator

In managing the whole Commercial Electronic Portfolio Management System 1, the Administrator 177 is the personality that is given such a responsibility. The Administrator 177 is not restricted to being just one single person, but rather as a noun to refer to a position in the system that various people can be assigned to.

In FIG. 3D, the role of the Administrator in the Remote Sales Personnel Content Management System 26 is illustrated. To manage this system, the Administrator logs-in to the Remote Sales Personnel Monitoring Account 157 which is independent and separate from the one viewable at the Remote Sales Personnel Management Home Page 190. Access to the Monitoring Account will allow the Administrator to manage his account profile 158, manage campaign settings 159, manage marketing materials 160 for each campaign, manage Remote Sales Personnel's profiles 161, and view statistics or usage reports 162 of the whole Remote Sales Personnel Content Management System 26. It is also the responsibility of the Administrator 177 to monitor the Payout Schedule 163. On the Payout Schedule date the Administrator sends the RSPs and the sub-RSPs their commissions 165. Also on the Non-Profits' Payout Schedule, the Administrator sends the Non-Profits the donations 166 credited to their account.

It is important to note that the personalities/entities involved in the sending of the commissions and donations are third-party entities and not part of the Implemented Website, in much the same way that the Auctioneer 183 and the Third-Party Auctioneer's Website 187 are not part of the Implemented Website. This means, the commissions of the Remote Sales Personnel and the donations for the Non-Profits are coursed through entities such as, but not limited to, online payment gateways, wire transfers, remittance service providers, escrow accounts, etc, according to the discretion of the RSP and Non-Profit. This approach is deemed most appropriate in addressing the issue of disbursement of commissions and donations since it offers more flexibility for the receipt of such for both the Administrator 177 and the Remote Sales Personnel.

Throughout the whole invention, the Administrator has the sole responsibility to ensure that the correct flow of the system is followed, and the potential for further improvements are also collaborated.

### Sustainable Business Method

As part of the invention's being a novel way of combining new and existing components, the inventor cited the capability of the system to create and develop unlimited number of jobs, sources of income, and fund raising sources for non-profits. This is made possible by the fact that all forms of business and services are based on the limitless capability of a person to imagine and create. Thus, as economies develop, more inventions are made, there will be constant Creation and Evolution of businesses, services and products 194, leading to more and more ways for income to be generated. Such creation and evolution can come from the minds of Builders, Advertisers, Customers and all Users 193 of the invention. These very same people will use and promote 195 these businesses, services and products through the various features of the Portfolios 196 available in the invention. The system will continue determining who their customers are, and the products/services they need/want; informing customers of their existence; showing them their products and services and getting them to purchase; tracking resources, billing and payments. The number of people needed as Builders 181 will also increase, thereby providing more jobs and sources of income 197 through the 1) job of a Builder 181; 2) assistance in the growth of new and existing businesses that would eventually hire more people, possibly the Builders 181 themselves; and 3) increase in the need to promote new and existing businesses, services, and products.

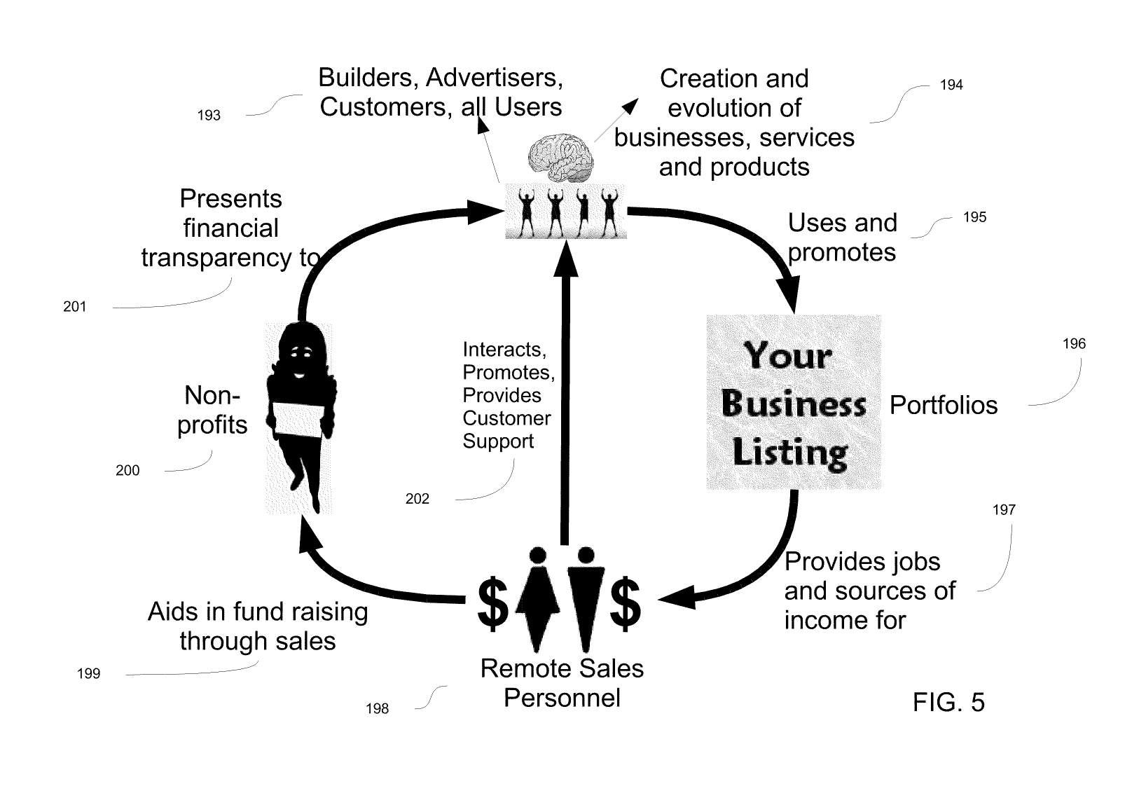

The Remote Sales Personnel 198 is then given the opportunity to earn commissions through the system as directly outsourced promoters of these businesses, services and products. By Interacting, Promoting, and Providing Customer Support 202 to all the Users 179 of the invention, they are further encouraged to continue the usage of the invention and the creation and development of even more portfolios. For every payment made to them for the maintenance of these portfolios, the Non-Profits 200 will be Aided in Fund Raising Through their Sales 199. To continually provide the needed transparency and encourage more people to support their projects, the Non-Profits 200 will thus Present Financial Transparency 201 to the Builders, Advertisers, Customers, and all Users 193 of the invention as previously explained in this specification. This cycle for sustainability is illustrated in FIG. 5.

The invention shall be sold under the trademark POSTTA-FOLIO. The POSTTA-FOLIO trademark is registered to Michelle Bayana Trillana, the invention's applicant, under Application No. 4-2009-990005 filed on Mar. 2, 2009 at the Philippine Intellectual Property Office with Nice Classification 42, Scientific and Technological Services and Research and Design relating thereto; Industrial Analysis and Research Services; Design and Development of Computer Software.

What is claimed:

1. A business method of combining an incentive or promotion program with an electronic commerce system using a collection of Content Management Systems over the World Wide Web comprising a computer-implemented collaboration of a Digital Directory Content Management System, Member Services System, Remote Sales Personnel System, Customer Relationship Management System, and Reputation System accessible over the World Wide Web as a Commercial Electronic Portfolio Management System representing the Sustainable Business Method for the purpose of advertising, job generation, and financial accountability monitoring, and the stimulation of trade on a local, national, and international scale.

2. A business method according to claim 1, wherein the computer-implemented Digital Directory Content Management System comprised of systems, functions, and arrangements of computerized information storage called a portfolio or directory listing is configured to contain a set of information on an individual or entity's various services and products offered as an online commercial product offered for free or for a price to any individual person or separate legal entity to advertise or make publicly available information about their products and services through the portability and convenience of remote retrieval and storage of data through the World Wide Web.

3. A business method according to claim 2, wherein every portfolio or directory listing is the central component of the invention created, stored and organized into an electronic directory of different livelihood and business activities as reference for business process outsourcing for the generation of advertising, jobs, and financial accountability.

4. A business method according to claim 2, wherein every portfolio or directory listing is the product and central component used in the implementation of the part of the invention where sales, commissions, and donations are derived from that directly affects the transactions in the Member Services System, Remote Sales Personnel System, Customer Relationship Management System, and Reputation System as a Sustainable Business Method.

5. A business method according to claim 1, wherein the Member Services Systems uses a Subscription System to collect, store, and process the necessary requirements to register, validate, maintain an online user's personal information as a member profile, control the permission levels of the various users to view or access the public or private components of the system through the Implemented Website, contain functions that allow members access to their own member-account control panel to view, maintain and update their own member-account profiles and other member-usable features of the system.

6. A business method according to claim 1, wherein all members of the Digital Directory Content Management System, called Builders, and the Remote Sales Personnel Content Management System, called Remote Sales Personnel, are required to be alive and human for the generation of unlimited number of online jobs as independent remote sales and marketing personnel for the online or offline promotion, marketing, reputation building, and customer relationship development of new and existing businesses, goods and services portfolios.

7. A business method according to claim 1, wherein the Remote Sales Personnel Content Management System is a web-based integrated sales, marketing, incentive, commissions and recruitment monitoring system, comprised of a Sales Campaign System, populated by Remote Sales Personnel and the Non-Profit Remote Sales Personnel using a multilevel online Recruitment Process.

8. A business method according to claim 7, wherein the Sales Campaign System is a configurable system for the creation, monitoring, recording, and development of various multi-level recruitment, commission and donation structures, containing sets of marketing and recruitment materials.

9. A business method according to claim 8, wherein each Sales Campaign assigns each Remote Sales Personnel a unique number or ID to identify the Sales Campaign the Remote Sales Personnel has joined to monitor online and offline for sales, marketing and recruitment performance processing.

10. A business method according to claim 8, wherein each Sales Campaign records, monitors and stores the commissions gained by the Remote Sales Personnel and donations due to be given to a non-profit beneficiary from sale of non-free portfolios or directory listings from the Digital Directory Content Management System.

11. A business method according to claim 9, wherein each Sales Campaign records, monitors, and stores the recruitment activities and performance of the Remote Sales Personnel for the generation of reports and content of visual performance monitoring tools.

12. A business method according to claim 10, wherein a sale of a portfolio or directory listings by a Remote Sales Personnel follows a Sales Transaction Process called a Claim Listing Module.

13. A business method according to claim 12, wherein the Claim Listing Module requires that the purchase of a portfolio or directory listing from a Remote Sales Personnel goes through a bidding process open to multiple bidders at a third-party online auction website with the minimum bid price determined by the Builder where winning bidder becomes the owner of the auctioned portfolio or directory listing.

14. A business method according to claim 13, wherein the winning bidder of the auctioned portfolio or directory listing is then required to pay a regularly scheduled subscription fee for the continuous maintenance of the online presence, marketing tasks, content updating tasks, customer relationship management tasks for the purchased portfolio or directory listing, and choose a verified and validated project of a member non-profit beneficiary to support.

15. A business method according to claim 14, wherein the regularly scheduled subscription fee is the regular income derived from the system to produce a Sustainable Business Method to provide regular commissions as regular income to the Remote Sales Personnel and Builders becoming recipients of job opportunities as independent remote sales and marketing personnel, and regular donations as funding for verified and validated projects of member non-profit beneficiaries.

16. A business method according to claim 6, wherein the Remote Sales Personnel of purchased portfolios or directory listings aid in the compilation of publicly recorded economic activities of individuals and enterprises, monitoring of business initiatives for the improvement of decision-making of both business owners and customers, and the creation and maintenance of an electronic directory of different livelihood and business activities as reference for more sources of jobs and income-generating opportunities.

17. A business method according to claim 6, wherein Non-Profit Organizations can register as both donee institutions and Remote Sales Personnel, represented by a live and human staff, to generate more funds for their socially responsible projects by combining income generated through commissions as Remote Sales Personnel and donations as donee institutions, in a way that is portable and cost-efficient to both donors and the non-profit organizations within a transparent financial accountability monitoring system.

18. A business method according to claim 1, wherein the Recruitment Process is the part of the system that is used to populate a multi-tier structure with Remote Sales Personnel where the depth and breadth of the multi-level structure and its commissions structure is based on the configured multi-level structure of the Sales Campaign the Remote Sales Personnel has joined.

19. A business method according to claim 1, wherein the Reputation System and Customer Relationship Management System are integrated into the system to enable customers to post feedback about the quality and value of products and services offered in the portfolio or directory listing to help build the reputation of member advertisers to potential and existing customers, develop a customer-centered certification of credits and credentials of the individuals and enterprises publicly listed in the Digital Directory Content Management System, encourage and motivate Builders and owners of portfolios or directory listings to implement and improve customer relations, and provide technical support to all users of the system.

20. A business method to address the economic need to generate jobs and income directly using the Remote Sales Personnel Content Management System and indirectly using the invention to assist in the promotion and growth of new and existing businesses to eventually hire more people for their own operations, using the information collected and made publicly available through the invention leading to the constant creation and evolution of businesses by propagating the limitless capability of a person to imagine and create new sources of complementary income-generating activities, services and products and serve as a conduit for economic growth on a local, national and international scale.
